(19) United States
(12) Patent Application Publication
(10) Pub. No.: US 2004/0050818 A1
(43) Pub. Date: Mar. 18, 2004

(54) Method of forming sunken relief in a piece of porcelain or of earthenware

(75) Inventor: Gilles Duval, Paris (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: COMPAGNIE DES ARTS DE LA TABLE, PARIS (FR)

(21) Appl. No.: 10/610,565

(22) Filed: Jul. 2, 2003

(30) Foreign Application Priority Data
Jul. 2, 2002 (FR) 02 08251

(51) Int. Cl. C03C 25/68

(52) U.S. Cl. 216/41

(57) ABSTRACT

A mask formed by printing a pattern onto backing, and having firstly uninterrupted resist portions (3) suitable for withstanding a jet of abrasive material and secondly openings serving to allow said abrasive material to pass through, is placed in front of the piece (8). At least facing the openings, a material (16) suitable for etching porcelain or earthenware is blasted onto the mask so as to obtain one or more sunken relief pits of desired shape and depth. The piece obtained by implementing this method has deep, mat, and clearly marked sunken relief.

The invention relates to a method of forming sunken relief in a piece of porcelain or of earthenware, and to a piece of porcelain or of earthenware obtained by implementing the method.

The invention is applicable in particular but not exclusively to dinner service pieces or to decorative pieces, such as plates, saucers, dishes, cups, ashtrays, etc.

Pieces of porcelain are generally decorated, it thus being possible to obtain a large range of different pieces in order to satisfy the varied expectations of the customers.

Document DD-229 859 discloses a method of forming sunken relief in a piece, in which method auxiliary decoration means are provided in the form of a PVC mask provided with openings. Those means are disposed on the piece and sand is blasted onto the mask in order to form the decoration.

Document DE-17 96 271 discloses a method of forming decorative patterns in relief in a piece of porcelain, in which method a mask from which the shape of the decorative pattern is cut out is disposed on the piece, and then sand is blasted facing the mask until it reaches the desired decoration depth in the piece.

Finally, Document U.S. Pat. No. 4,263,085 describes a method of forming decorative patterns in relief in a piece, in which method a mask is cut out from a plastic film disposed on a backing film. A transfer film is then applied to the mask and backing film assembly and the mask is separated from the backing and adheres to the transfer film. The transfer film is applied to the piece, and then removed so as to leave the mask secured to the piece. Sandblasting then makes it possible to form the decorative pattern or “indicia” in the piece.

Unfortunately, the above-described methods implement masks from which the desired decorative shapes are cut out, which requires cutting operations and cutting tools. In addition, the resulting masks are designed to be held apart from the piece to be decorated or to be stuck onto the piece. That therefore requires either the mask to be held apart from the piece by means of a particular device or by hand, or else a step in which the mask is glued to the piece.

Finally, forming complex or fine patterns requires great precision in forming the shapes of the patterns. That is difficult or even impossible to achieve when the pattern is formed by cutting, e.g. by means of a press, as it is in Document U.S. Pat. No. 4,263,085.

An object of the invention is to provide a decoration method that makes it possible to obtain novel types of decorative patterns that cannot be formed with prior art methods, so as to offer porcelain enthusiasts a new range of pieces, in particular with complex or fine patterns.

In particular, an object of the invention is to provide a decoration method that makes it possible to obtain clean-cut and relatively deep sunken relief.

Another object of the invention is to provide a decoration method that requires fewer manual operations, and that can be industrialized, at least in part.

To this end, in a first aspect, the invention provides a method of forming sunken relief in a piece of porcelain or of earthenware, in which method:

a mask is provided that has firstly uninterrupted resist portions suitable for withstanding a jet of abrasive material, and secondly openings for allowing said abrasive material to pass through;

the mask is placed in front of the piece; and

a material suitable for etching porcelain or earthenware is blasted onto the mask at least facing the openings so as to obtain one or more sunken relief pits of desired shape and depth;

the method further comprising the following steps:

the mask is printed on backing;

the backing is covered with a film over and in the vicinity of the printed mask;

the mask and film assembly is separated from the backing;

the mask and film assembly is applied to the piece; and

the film is removed, the mask remaining secured to the piece.

The mask may cover the entire piece to be decorated.

It is also possible for a substance that is initially liquid and that is suitable for forming a mask after drying to be applied to the piece.

According to other characteristics, an abrasive material in particle form, such as sand or corundum, is blasted onto the piece, it being possible for the particles to be of diameter lying in the range 100 μm to 150 μm.

For example, the material is blasted onto the piece by means of at least one nozzle, and the piece is moved relative to the nozzle so as to blast the material over the entire desired area of the piece.

After the material has been blasted onto the piece, said piece is generally cleaned, the mask being removed by washing or by brushing.

In a second aspect, the invention provides a piece of porcelain or of earthenware obtained by the above-described method.

By means of the method of the invention, the outlines of the sunken relief pits are clearly marked and substantially free of transitional connection shoulders. In addition, by printing the pattern on backing, it is possible to form a complex pattern and to omit a tedious cutting step in which the shape of the pattern is cut out from the mask.

Finally, in a third aspect, the invention provides a mask for implementing the above-described method. The mask has firstly uninterrupted resist portions suitable for withstanding a jet of abrasive material, and secondly openings serving to allow said abrasive material to pass through, said openings being organized to enable one or more sunken relief pits of desired shape to be obtained in the piece.

Other characteristics of the invention appear from the following description given with reference to the accompanying drawings, in which:

FIG. 1 is a plan view of backing on which a mask is printed, said backing being covered with a film;

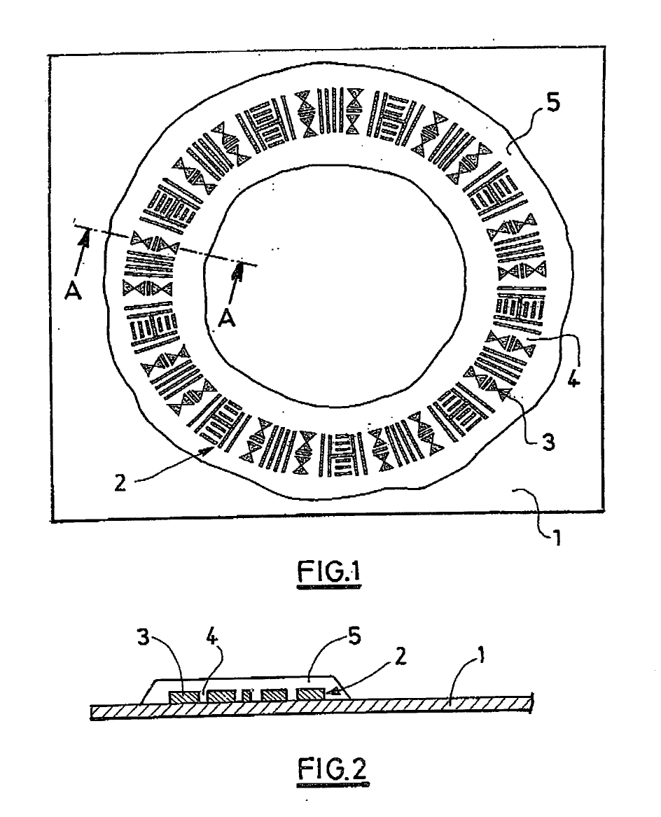

FIG. 2 is a view in section on line AA of FIG. 1;

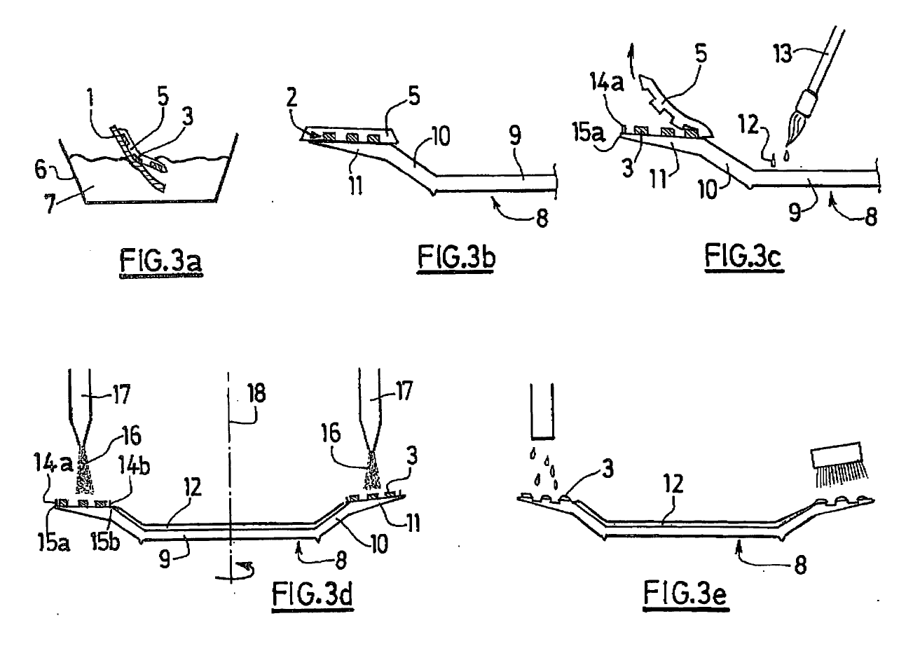

FIGS. 3a to 3e diagrammatically show the various steps in the method of the invention;

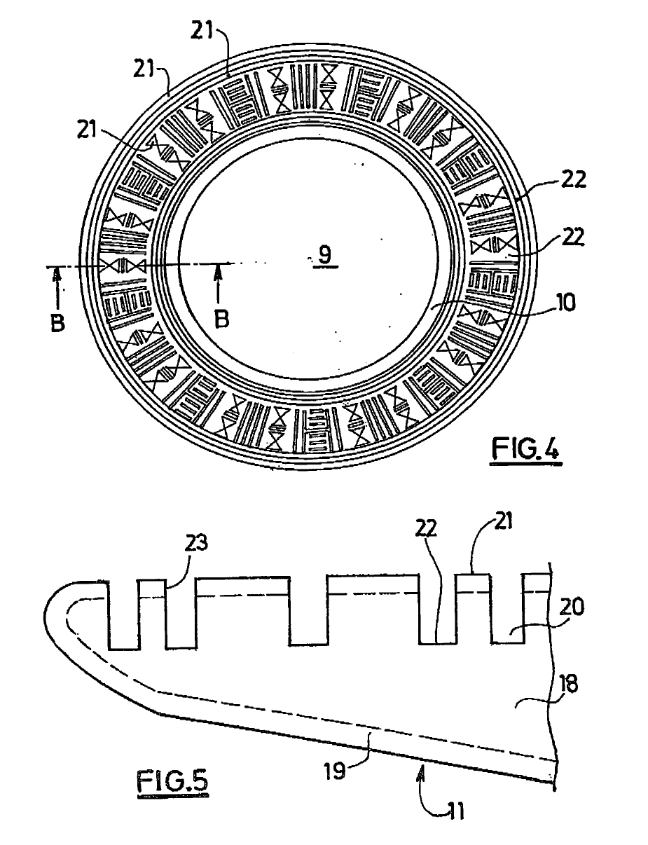

FIG. 4 is a plan view of a plate obtained by implementing the method of the invention, using the mask of FIG. 1;

FIG. 5 is a fragmentary section view on line BB of FIG. 4;

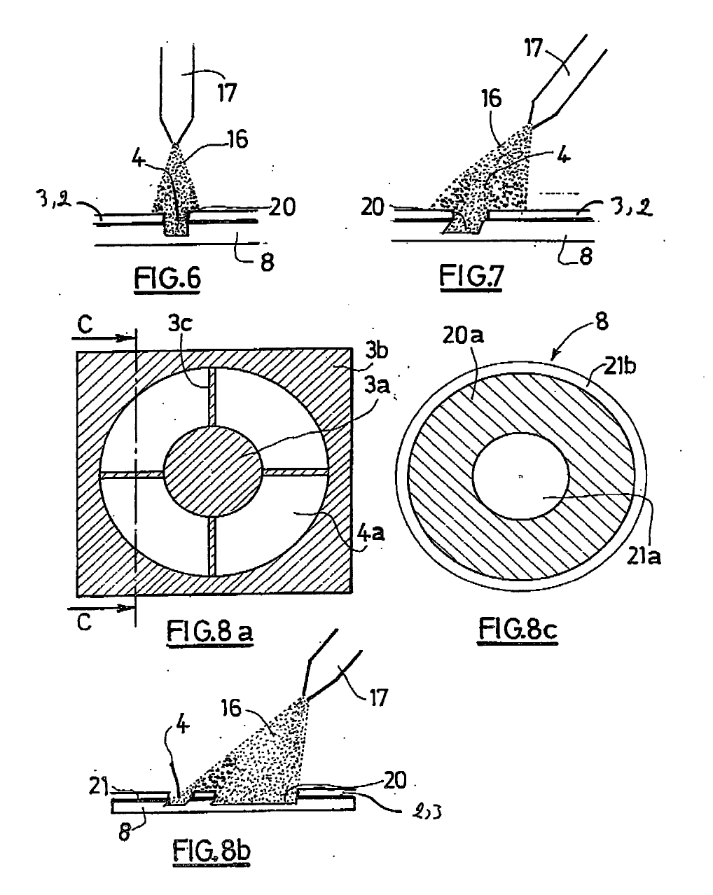

FIGS. 6 and 7 show two implementations for blasting abrasive material onto a piece;

FIG. 8a is a plan view of a mask;

FIG. 8b is a view in section of the mask of FIG. 8a on line CC, associated with a piece subjected to a jet of abrasive material; and

FIG. 8c is a plan view of the piece shown in FIG. 5b, obtained after blasting.

Reference is made firstly to FIGS. 1 and 2.

On backing 1, such as a sheet of gummed paper, a mask 2 is printed that is made up of printed portions 3 (shown in grey shading) and of openings 4 (shown in white). For example, the mask 2 may be screen printed onto the backing 1.

Printing the mask by screen printing makes it possible to implement fine and complex patterns that are difficult to achieve by cutting out the shape of the pattern from a mask.

The mask 2 is to be applied to a piece of porcelain or of earthenware, prior to said piece being blasted with an abrasive material for the purpose of forming sunken relief in said piece.

The mask 2 acts in the manner of a stencil Firstly, the openings 4 serve to allow the abrasive material to pass through. Secondly, the printed portions 3 are made of a material that withstands the jet of abrasive material, e.g. a film of plastic. As a result, the printed portions 3 protect those portions of the piece on which they are applied.

The mask 2 thus makes it possible for sunken relief to be formed in the piece on which it is applied.

The mask 2 printed on the backing 1 is covered with a film 5 of varnish, both over the printed portions 3 and over the openings 4. The film 5 also covers a portion of the backing 1, in the vicinity of the mask 2.

The mask 2 has a shape designed to match the piece on which it is to be applied. In the implementation shown, the mask and film assembly 2 & 5 is substantially annular, and it is designed to be applied on the rim of a plate.

A description follows of the various steps in the method of the invention that make it possible to form the sunken relief on the piece of porcelain or of earthenware, the description being given with reference to FIGS. 3a to 3e.

Firstly, the backing 1, the mask 2, and the film 5 are put to soak in a receptacle 6 containing a liquid 7, e.g. water, thereby making it possible to soften the mask and film assembly 2 & 5 and to separate it from the backing 1 (FIG. 3a). The film 5 then forms a backing element for the printed portions 3 of the mask 2.

The mask and film assembly 2 & 5 is then transferred to a piece 8 of porcelain or of earthenware, with a view to decorating said piece 8.

The piece 8 shown in section in the figures is a plate, and it comprises a bottom 9 that is substantially disk-shaped and plane, a slanting wall 10 that is substantially frustoconical and that extends outwards from the periphery 9 of the bottom, and an annular rim 11, that is substantially parallel to the bottom 9, and that extends the slanting wall 10.

Naturally, the invention is not limited to plates having this shape, and it is applicable to any piece of porcelain or of earthenware, in particular to any dinner service piece or decorative piece.

Once the mask and film assembly 2 & 5 is softened by the contact with the liquid 7, it can be applied manually to the piece 8 and can intimately hug the shapes (even complex shapes) of any piece 8, so that the desired pattern can be formed on the piece 8.

In the implementation shown, the mask and film assembly 2 & 5 is substantially annular, and it is applied to the rim 11 of the plate (FIG. 3b).

Once the mask and film assembly 2 & 5 has dried, the film 5 of varnish is removed by being peeled off, e.g. by pulling on a tear tab provided for this purpose, the mask 2 remaining secured to the piece 8 (FIG. 3c).

Thus, it is not necessary to use an adhesive to secure the mask to the piece to be decorated, which simplifies the steps of the method and poses fewer problems when cleaning the piece once the patterns have been formed in it.

It should be noted that in FIGS. 3a to 3e, the mask 2 is shown enlarged relative to the piece 8 in order to facilitate understanding.

A substance 12 that is initially liquid, e.g. the same varnish as the varnish of the film 5 may be applied to any additional portions of the piece 8 that must be protected.

Said substance 12 is applied by means of a brush 13, and it is suitable for forming a mask after drying (FIG. 3c). For example, the substance 12 is applied to the bottom 9 of the plate, to the slanting wall 10, and to a first circle 14a situated in the vicinity the outer edge 15a of the rim 11 of the plate, and to a second circle 14b situated in the vicinity of the inner edge 15b of the rim 11 of the plate.

Applying the substance 12 with a brush 13 offers precision and thus makes it possible to perform touching-up should that be necessary after the mask 2 has been positioned incorrectly on the piece 8.

In a possible variant to masking using a brush, a resin mask can be positioned over the zone to be protected, e.g. the bottom 9 and the slanting wall 10 of the plate.

Once these protection operations have been finished, the piece 8 is inserted into a sandblasting booth, and the engraving proper is performed.

The piece 8 is blasted with an abrasive material 16 in the form of particles, such as sand or corundum particles, of diameter lying in the range 100 μm to 150 μm, and in particular in the vicinity of 120 μm.

The abrasive material 16 is blasted via nozzles 17 at a pressure lying in the range 3 bars to 3.5 or 4 bars, the piece 8 being moved relative to the nozzles 17 so as to expose all of the desired area of the piece 8 to the jet of abrasive material 16.

For the plate shown in FIG. 3d, two nozzles 17 are placed so that each of them faces the rim 11, in diametrically opposite manner. Each nozzle 17 covers an area of about 2 cm². The plate is caused to turn about its axis 18, so that the entire rim 11 is subjected to the jet of abrasive material 16. The plate turns relatively slowly, i.e. about 6 revolutions per minute (rpm) to 8 rpm, the rotation time being approximately in the range 5 minutes to 10 minutes, e.g. 7 minutes.

This configuration for the nozzles 17 may naturally be modified, as may the number of nozzles 17, as a function of the shape of the piece 8 and of the desired positions of the decoration on said piece 8.

Precise control of various parameters (air pressure, flow rate, nozzle inclination, nozzle height, type of abrasive used, grain-size, etc.) is performed, in particular with a view to obtaining the desired aesthetically pleasing effects.

As indicated above, the portions of the piece 8 that are covered with printed portions 3 of the mask 2 are protected from being etched by the abrasive material 16, while the portions of the piece 8 that are situated facing the openings 4 in the mask 2 are etched by the abrasive material 16, thereby resulting in sunken relief being formed in the piece 8 by engraving.

After a determined time, the piece 8 is removed from the sandblasting booth.

The piece 8 is then cleaned as shown in FIG. 3e. During this cleaning, the printed portions 3 of the mask 2, and any additional mask made of resin, can be removed either by washing, or by brushing.

An example of a resulting piece 8 is shown in FIGS. 4 and 5.

FIG. 5 shows the engraved rim 11 of the plate in section, the dashed line indicating the boundary between the central layer of unglazed material 18 and the surface layer of glazing 19.

The piece 8 has sunken relief 20 corresponding to the openings 4 in the mask 2, and zones 21 that are not etched because they were protected during the blasting with the abrasive material 16 by the printed portions 3 of the mask 2.

The depth of the sunken relief pits 20 lies in the range 1 mm to 3 mm, and in particular in the range 1.2 mm to 2 mm. Therefore, and as shown in FIG. 5, the engraving is performed to beyond the glazing 19, etching into the unglazed layer 18 as well.

The method of the invention thus makes it possible to obtain pieces having very deep sunken relief without this posing any technical or aesthetic problem.

The bottoms 22 of the sunken relief pits 20 are mat in appearance, whereas the zones 21 that are not etched by the abrasive material 16 have the gloss appearance of porcelain or of earthenware.

In addition, the edges 23 that connect the sunken relief pits 20 to the non-etched zones 21 are substantially vertical. Thus the outlines of the sunken relief pits are extremely precise, clearly-defined, and clean-cut, since the edges 23 are substantially free of any transitional connection shoulders, as shown in FIG. 5. Thus, the sunken relief pits 20 are clearly visible, and the non-etched zones 21 stand out clearly as projecting relative to the sunken relief pits 20. It is thus possible to achieve decorative patterns that are more marked and deeper than conventional decorative patterns.

Because of its novel, sober, and original aesthetic appearance, it is possible for the resulting piece to have no decoration other than the engraving itself.

The method of the invention includes only one manual step, namely transferring the mask 2 to the piece 8 to be decorated, the other operations being performed in automated manner. This results in considerable savings in time and in cost.

FIGS. 6 to 7 show other implementations of the invention.

The mask 2 made up of the uninterrupted zones 3 and of at least one opening 4 is placed on the piece 8. The nozzle 17 blasts the abrasive material 16 onto the mask 2 facing the piece 8 at least over the openings.

In FIG. 6, the jet of abrasive material 16 is directed substantially perpendicularly to the piece 8. As a result, the sunken relief pits 20 formed in the piece 8 are of shapes corresponding to the shapes of the openings 4.

In FIG. 7, the jet of abrasive material 16 is inclined at an angle of less than 90° relative to the piece 8. Thus, the shape of the resulting sunken relief 20 is not identical to the shape of the corresponding opening 4 in the mask 2.

FIG. 8a shows a mask 2 comprising:

a central portion 3a that is uninterrupted and disk-shaped;

around the central portion 3a, an opening 4a that is crown-shaped;

around the opening 4a, a peripheral portion 3b that is uninterrupted, e.g. having a rectangular outline; and

very fine uninterrupted spokes 3c connecting the central portion 3a to the peripheral portion 3b.

By blasting the piece 8 with abrasive material 16 in inclined manner, with the mask being interposed between the piece 8 and the nozzle 17, sunken relief pits 20 are obtained that do not correspond to the shapes of the openings 4 in the mask (FIG. 5b).

A second blasting with abrasive material 16 symmetrically about a plane P perpendicular to the piece 8, gives the piece 8 shown in FIG. 5c.

Because the abrasive material 16 is blasted in inclined manner, the uninterrupted spokes 3c do not protect the facing surface of the piece S. Thus, the piece has:

a central portion 21a that is not etched because it is protected by the uninterrupted central portion 3a of the mark 2;

a sunken relief band 20a (shown by hatching) that does not include non-etched spokes; and

a peripheral portion 21b that is not etched because it is protected by the peripheral portion 3b of the mask 2.

In general, the openings 4 in the mask 2 and the orientation of the nozzle 17 are chosen so as to obtain sunken relief 20 of the desired shape in the piece 8.

1. A method of forming sunken relief (20) in a piece (8) of porcelain or of earthenware, in which method:
a mask (2) is provided that has firstly uninterrupted resist portions (3) suitable for withstanding a jet of abrasive material, and secondly openings (4) for allowing said abrasive material to pass through;
the mask (2) is placed in front of the piece (8); and
a material (16) suitable for etching porcelain or earthenware is blasted onto the mask (2) at least facing the openings (4) so as to obtain one or more sunken relief pits (20) of desired shape and depth;
said method being characterized in that it further comprises the following steps:
the mask (2) is printed on backing (1);
the backing (1) is covered with a film (S) over and in the vicinity of the printed mask (2);
the mask and film assembly (2 & 5) is separated from the backing (1);
the mask and film assembly (2 & 5) is applied to the piece (8); and
the film (5) is removed, the mask (2) remaining secured to the piece (8).

2. A method according to claim 1, characterized in that the mask (2) is printed on the backing (1) by screen printing.

3. A method according to claim 1 or 2, characterized in that a substance (12) that is initially liquid and that is suitable for forming a mask (2) after drying is applied to the piece (8).

4. A method according to any one of claims 1 to 3, characterized in that the mask (2) covers the entire piece (8).

5. A method according to any one of claims 1 to 4, characterized in that an abrasive material (16) in particle form is blasted onto the piece (8).

6. A method according to any one of claims 1 to 5, characterized in that sand or corundum is blasted onto the piece (8).

7. A method according to any one of claims 1 to 6, characterized in that the blasted material (16) is in the form of particles of diameter lying in the range 100 μm to 150 μm.

8. A method according to any one of claims 1 to 7, characterized in that the material (16) is blasted under a pressure of approximately in the range 3 to 4 bars.

9. A method according to any one of claims 1 to 8, characterized in that the material (16) is blasted onto the piece (8) by means of at least one nozzle (17), and in that the piece (8) is moved relative to the nozzle (17) so as to blast the material (16) over the entire desired area of the piece (8).

10. A method according to any one of claims 1 to 9, characterized in that, after the material (16) has been blasted onto the piece (8), said piece (B) is cleaned, the mask (2) being removed by washing or by brushing.

11. A piece of porcelain or of earthenware obtained by the method according to any preceding claim.

12. A piece according to claim 11, characterized in that it has sunken relief (20) of depth lying in the range 1 mm to 3 mm.

13. A piece according to claim 12, characterized in that the bottoms (22) of the sunken relief (20) are mat.

14. A piece according to claim 13, characterized in that the sunken relief (20) is clearly marked and substantially free of transitional connection shoulders.

15. A mask for implementing the method according to any one of claims 1 to 10, characterized in that it has firstly uninterrupted resist portions (3) suitable for withstanding a jet of abrasive material, and secondly openings (4) serving to allow said abrasive material to pass through, said openings (4) being organized to enable one or more sunken relief pits (20) of desired shape to be obtained in the piece (8).
